(19) United States
(12) Patent Application Publication
(10) Pub. No.: US 2025/0163291 A1
(43) Pub. Date: May 22, 2025

(54) POLYMER BINDER BASED ON 2-OCTYL ACRYLATE, N-BUTYL ACRYLATE AND METHYL METHACRYLATE FOR AQUEOUS COATING COMPOSITIONS CONTAINING TITANIUM DIOXIDE

(71) Applicant: BASF SE, Ludwigshafen am Rhein (DE)

(72) Inventors: Friederike FLEISCHHAKER, Ludwigshafen am Rhein (DE); Andrea MISSKE, Ludwigshafen am Rhein (DE); Christoph FLECKENSTEIN, Ludwigshafen am Rhein (DE); Sabine EICHHORN, Ludwigshafen am Rhein (DE)

(21) Appl. No.: 18/835,143

(22) PCT Filed: Feb. 3, 2023
(86) PCT No.: PCT/EP2023/052685

§ 371 Date: Aug. 1, 2024

(30) Foreign Application Priority Data
Feb. 4, 2022 (EP) 22155150.0

(51) Int. Cl. C09D 133/26; C09D 5/02; C09D 7/61; C09D 7/65

(52) U.S. Cl. CPC C09D 133/26; C09D 5/022; C09D 7/61; C09D 7/65

(57) ABSTRACT

An aqueous polymer latex obtainable by polymerizing, optionally in the presence of a seed latex, a monomer composition M by radical emulsion polymerization, wherein the monomer composition M comprises, based on the total weight of the monomer composition M: a) 0.5 to 30% by weight of 2-octyl acrylate, b) 25 to 55% by weight of n-butyl acrylate, c) 35 to 65% by weight of methyl methacrylate, d) 0 to 5% by weight of one or more monoethylenically unsaturated carboxylic acids, e) 0 to 5% by weight of one or more monoethylenically unsaturated carboxylic acid amides, f) 0 to 10% by weight of one or more further ethylenically unsaturated non-ionic monomers different from monomers a), b), c), d) and e).

The invention relates to an aqueous polymer latex obtainable by polymerizing a monomer composition M comprising 2-octyl acrylate, n-butyl acrylate and methyl methacrylate. The invention further relates to the use of the aqueous polymer latex as a binder in an aqueous coating composition containing a titanium dioxide pigment and the invention also relates to an aqueous coating composition containing the aqueous polymer latex and a titanium dioxide pigment.

Titanium dioxide (TiO₂) is frequently used as a pigment in waterborne coating compositions, such as latex paints. Besides whiteness, TiO₂ provides opacity or hiding power, respectively, to the coating, which means that the coating is opaque and concealingly covers an undersurface or substrate surface to which the coating is applied.

WO2017/191167 discloses an aqueous polymer latex that is used as binder in waterborne coating compositions containing a titanium dioxide pigment. The aqueous polymer latex is obtained by polymerizing a monomer composition M by radical emulsion polymerization using a specific feed method, where the monomer composition M consists of
a) 80 to 99.95% by weight, based on the total weight of the monomer composition M, of ethylenically unsaturated monomers M1, which are selected from mixtures of at least one monomer M1a, selected from C₁-C₂₀-alkyl esters of acrylic acid and C₅-C₂₀-alkylesters of methacrylic acid; and at least one monomer M1b, selected from vinyl aromatic monomers and C₁-C₄-alkyl esters of methacrylic acid;
b) 0.05 to 5% by weight, based on the total weight of the monomer composition M, of one or more monoethylenically unsaturated monomers M2, which are selected from monoethylenically unsaturated monocarboxylic acids having 3 to 6 carbon atoms and monoethylenically unsaturated dicarboxylic acids having 4 to 6 carbon atoms;
c) 0 to 20% by weight of non-ionic monomers M3, which are different from monomers M1.

Preferred monomers M1a are C₂-C₁₀-alkyl esters of acrylic acid, in particular ethyl acrylate, n-butyl acrylate, n-hexyl acrylate, n-octyl acrylate, 2-ethylhexyl acrylate and 2-propylheptyl acrylate. Preferred monomers M1b are vinylaromatic monomers and mixtures of vinylaromatic monomers with C₁-C₄-alkyl esters of methacrylic acid. In particular, monomers M1b are selected from styrene and mixtures of styrene with methyl methacrylate. Preferred monomers M2 are acrylic acid and methacrylic acid. Preferred monomers M3 are hydroxy-C₂-C₄-alkylesters of acrylic acid and methacrylic acid.

WO2014/207389 A1 concerns the use of a polymer resulting from the polymerization of 2-octyl acrylate of renewable origin and optionally at least one other monomer, as binding agent in or for the manufacture of a coating composition. The other monomer is preferably chosen from esters of ethylenically unsaturated mono- and dicarboxylic acids, in particular methyl methacrylate and n-butyl acrylate, vinylaromatic monomers, more particularly styrene, and their mixtures. The document discloses clear coatings.

WO 2016/128574 concerns an aqueous polymer emulsion comprising at least 30 wt. % of a vinyl copolymer (A), said vinyl copolymer comprising:
(I) from 10 to 90 wt. % of 2-octyl acrylate monomer;
(II) from 10 to 90 wt. % of at least one itaconate ester monomer; and
(III) from 0 to 80 wt. % of ethylenically unsaturated monomer other than (I) and (II).

The other ethylenically unsaturated monomers (III) comprise acrylic acid and/or methacrylic acid and monomers selected form methyl (meth)acrylate, ethyl (meth)acrylate, butyl (meth)acrylate, styrene and combinations thereof.

WO2018/007325 A1 discloses an aqueous emulsion comprising at least 30 wt. % of vinyl copolymer(s) (A), said vinyl copolymer(s) (A) containing the following monomers:
(I) isobornyl methacrylate and 2-octyl acrylate in a summed amount of at least 30 wt. %, in a weight ratio of isobornyl methacrylate to 2-octyl acrylate from 5:95 to 95:5;
(II) no more than 70 wt. % of at least one ethylenically unsaturated monomer other than 2-octyl acrylate and isobornyl methacrylate. The other ethylenically unsaturated monomers (II) comprise acrylic acid and/or methacrylic acid and monomers selected form methyl (meth)acrylate, ethyl (meth)acrylate, butyl (meth)acrylate, styrene and combinations thereof. The document discloses clear coatings.

It is an object of the present invention to provide alternative methyl methacrylate (MMA) copolymers having a comparable glass transition temperature to copolymers based on methyl methacrylate and n-butyl acrylate (BA) which are suitable as a binder for architectural coatings containing TiO₂ with good scrub resistance, thickening efficiency, gloss and opacity as well as good adhesion, stain resistance, and low dirt pick-up.

The object is solved by an aqueous polymer latex obtainable by polymerizing a monomer composition M by radical emulsion polymerization, wherein the monomer composition M comprises, based on the total weight of the monomer composition M:
a) 0.5 to 30% by weight of 2-octyl acrylate,
b) 25 to 55% by weight of n-butyl acrylate,
c) 35 to 65% by weight of methyl methacrylate
d) 0 to 5% by weight of one or more monoethylenically unsaturated carboxylic acids,
e) 0 to 5% by weight of one or more monoethylenically unsaturated carboxylic acid amides,
f) 0 to 10% by weight of one or more further ethylenically unsaturated non-ionic monomers different from monomers a), b), c), d) and e).

It has surprisingly been found that the copolymer of the invention based on 2-octyl acrylate, n-butyl acrylate (BA) and methyl methacrylate (MMA) leads to improved scrub resistance, improved gloss and improved thickening efficiency, as well as comparable opacity, adhesion, stain resistance and dirt pick-up as compared to a copolymer based on n-butyl acrylate and methyl methacrylate in comparably formulated architectural coatings.

Preferably, 2-octyl acrylate, n-butyl acrylate and methyl methacrylate account for at least 95% by weight of the monomer composition M. For example, 2-octyl acrylate may be present in an amount of 1 to 15% by weight, n-butyl acrylate may be present in an amount of 25 to 55% by weight and methyl methacrylate may be present in an amount of 40 to 65% by weight of the monomer mixture M.

Preferably, the monoethylenically unsaturated carboxylic acid d) is selected from the group consisting of acrylic acid, methacrylic acid, maleic acid, half methyl ester of maleic acid, half ethyl ester of maleic acid, citraconic acid, half methyl ester of citraconic acid, itaconic acid, half methyl ester of itaconic acid, 3-pentenoic acid, 2-butenoic acid, fumaric acid, half methyl ester of fumaric acid, half ethyl ester of fumaric acid, halogenated acrylic acids and halogenated methacrylic acids. Most preferably, monomer d) is selected from acrylic acid, methacrylic acid and itaconic acid.

Preferably, the monoethylenically unsaturated carboxylic acid amide e) is selected from the group consisting of acrylamide, methacrylamide, N-methyl acrylamide, N-ethyl acrylamide, N-propyl acrylamide, N-isopropyl acrylamide, N-butyl acrylamide, N-methyl methacrylamide, N-ethyl methacrylamide, N-propyl methacrylamide, N-isopropyl methacrylamide and N-butyl methacrylamide. Most preferably, monomer e) is selected from acrylamide and methacrylamide.

In preferred embodiments, monomer d) is present in an amount of 0.1 to 4% by weight. In more preferred embodiments, monomer d) is present in an amount of 0.5 to 3% by weight, even more preferred of 0.5 to 2% by weight, based on the total weight of the monomer composition.

In further preferred embodiments, monomer e) is present in an amount of 0.1 to 4% by weight. In more preferred embodiments, monomer e) is present in an amount of 0.5 to 3% by weight, even more preferred of 1 to 3% by weight, based on the total weight of the monomer composition.

Monomer f), if present, is preferably selected from the group consisting of C₂-C₁₀-alkyl esters of acrylic acid, in particular tert-butyl acrylate, 2-propylheptyl acrylate, n-octyl acrylate, 2-ethylhexyl acrylate, C₁-C₄-alkyl esters of methacrylic acid different from methyl methacrylate, in particular 2-ethylhexyl methacrylate, butyl methacrylate and tert-butyl methacrylate, and vinylaromatic monomers, in particular styrene.

In further preferred embodiments, monomer f) is not present in the monomer composition M.

In preferred embodiments, the monomer composition M comprises or consists of
a) 1 to 15% by weight, more preferably 3 to 12% by weight by weight of 2-octyl acrylate,
b) 25 to 55% by weight, more preferably 30 to 50% by weight of n-butyl acrylate,
c) 40 to 65% by weight, more preferably 40 to 60% by weight of methyl methacrylate,
d) 0 to 5% by weight of one or more monoethylenically unsaturated carboxylic acids,
e) 0 to 5% by weight of one or more monoethylenically unsaturated carboxylic acid amides.

In more preferred embodiments, the monomer composition M comprises or consists of
a) 1 to 15%, more preferably 3 to 12% by weight by weight of 2-octyl acrylate,
b) 25 to 55% by weight, more preferably 30 to 50% by weight of n-butyl acrylate,
c) 40 to 65% by weight, more preferably 40 to 60% by weight of methyl methacrylate,
d) 0 to 5% by weight of one or more monoethylenically unsaturated carboxylic acids, selected from acrylic acid, methacrylic acid and itaconic acid,
e) 0 to 5% by weight of one or more monoethylenically unsaturated carboxylic acid amides, selected from acrylamide and methacrylamide.

In particularly preferred embodiments, the monomer composition M consists of
a) 3 to 12% by weight of 2-octyl acrylate,
b) 30 to 50% by weight of n-butyl acrylate,
c) 40 to 60% by weight of methyl methacrylate,
d) 0 to 5% by weight of acrylic acid,
e) 0 to 5% by weight of acrylamide.

In some preferred embodiments, the monomer composition M consists of:
a) 3 to 12% by weight of 2-octyl acrylate,
b) 30 to 50% by weight of n-butyl acrylate,
c) 40 to 60% by weight of methyl methacrylate,
d) 0.1 to 4% by weight of a monoethylenically unsaturated carboxylic acid, selected from acrylic acid, methacrylic acid and itaconic acid,
e) 0.1 to 4% by weight of a monoethylenically unsaturated carboxylic acid amide, selected from acrylamide and methacrylamide.

In some preferred embodiments, the monomer composition M consists of:
a) 3 to 12% by weight of 2-octyl acrylate,
b) 30 to 50% by weight of n-butyl acrylate,
c) 40 to 60% by weight of methyl methacrylate,
d) 0.5 to 3% by weight by weight of acrylic acid,
e) 0.5 to 3% by weight by weight of acrylamide.

In some preferred embodiments, at least part of the 2-octyl acrylate of component a) has been produced from renewable raw materials, i. e. at least part of the 2-octyl acrylate of component a) is a bio-based 2-octyl acrylate that has been partially or completely obtained from renewable raw materials. Also mixtures of 2-octyl acrylate obtained from fossil raw materials and 2-octyl acrylate partially or completely obtained from renewable raw materials can be used.

2-Octyl acrylate can be e.g. synthesized by esterification of acrylic acid with 2-octanol or transesterification of e.g. methyl acrylate or ethyl acrylate with 2-octanol.

Preferably, the bio-based 2-octyl acrylate is obtained by the reaction of 2-octanol with acrylic acid. Hereby, the 2-octanol and/or the acrylic acid and/or methyl acrylate and/or ethyl acrylate are at least partially produced from renewable raw materials.

Bio-based 2-octanol from renewable raw materials can be obtained from castor oil. Acrylic acid from renewable raw materials can be prepared e.g. according to WO 2006/092272 or DE 10 2006 039 203 A or EP 2 922 580.

It is also possible that at least part of the educts used to synthesize the monomer composition M are from renewable raw materials according to the mass balance approach. Accordingly, in addition to fossil feeds, also renewable feeds such as bio-naphtha (as e.g. described in EP 2 290 045 A1 or EP 2 290 034 A1) enter the chemical production system, such as a steam cracker. The renewable feeds are converted into products along the chemical value chain, such as acrylic acid, butyl acrylate, methyl methacrylate or acrylamide. The content of renewable material of these products is defined by the mass balance approach and can be allocated to these products.

The process for the preparation of the polymer latex is performed according to the well-known processes of radical emulsion polymerisation technology. The conditions required for the performance of the free-radical emulsion polymerization of the monomers M are sufficiently familiar to those skilled in the art, for example from the prior art cited at the outset and from “Emulsions-polymerisation” [Emulsion Polymerization] in Encyclopedia of Polymer Science and Engineering, vol. 8, pages 659 ff. (1987); D. C. Blackley, in High Polymer Latices, vol. 1, pages 35 ff. (1966); H. Warson, The Applications of Synthetic Resin Emulsions, chapter 5, pages 246 ff. (1972); D. Diederich, Chemie in unserer Zeit 24, pages 135 to 142 (1990); Emulsion Polymerisation, Interscience Publishers, New York (1965); DE-A 40 03 422 and Dispersionen synthetischer Hochpolymere [Dispersions of Synthetic High Polymers], F. Holscher, Springer-Verlag, Berlin (1969).

The free-radically initiated aqueous emulsion polymerization is triggered by means of a free-radical polymerization initiator (free-radical initiator). These are in principle peroxides, azo compounds and redox initiator systems. The peroxides can be inorganic peroxides or organic peroxides.

In certain embodiments, the inorganic peroxide is selected from the group consisting of hydrogen peroxide and persulfates, such as the mono- or di-alkali metal or ammonium salts of persulfuric acid, for example the mono- and disodium, -potassium or ammonium salts.

In other embodiments, the organic peroxide is selected from the group consisting of alkyl hydroperoxides, for example tert-butyl hydroperoxide, p-menthyl hydroperoxide or cumyl hydroperoxide, and dialkyl or diaryl peroxides, such as di-tert-butyl or di-cumyl peroxide.

In further embodiments, the azo compound is selected from the group consisting 2,2′-azobis(isobutyronitrile), 2,2′-azobis(2,4-dimethylvaleronitrile) and 2,2′-azobis(amidinopropyl) dihydrochloride.

In preferred embodiments, the free-radical initiators are inorganic peroxides, especially persulfates, and redox initiator systems.

Suitable oxidizing agents for redox initiator systems are essentially the peroxides specified above. Corresponding reducing agents which may be used are sulfur compounds with a low oxidation state, such as alkali metal sulfites, for example potassium and/or sodium sulfite, alkali metal hydrogensulfites, for example potassium and/or sodium hydrogensulfite, alkali metal metabisulfites, for example potassium and/or sodium metabisulfite, formaldehyde sulfoxylates, for example potassium and/or sodium formaldehyde sulfoxylate, alkali metal salts, specifically potassium and/or sodium salts of aliphatic sulfinic acids and alkali metal hydrogensulfides, for example potassium and/or sodium hydrogensulfide, salts of polyvalent metals, such as iron(II) sulfate, iron(II) ammonium sulfate, iron(II) phosphate, ene diols, such as dihydroxymaleic acid, benzoin and/or ascorbic acid, and reducing saccharides, such as sorbose, glucose, fructose and/or dihydroxyacetone.

In an embodiment, the amount of free-radical initiator for the emulsion polymerization M is initially charged in the polymerization vessel completely. However, it is also possible to charge none of or merely a portion of the free-radical initiator, e.g. not more than 40% by weight, especially not more than 30% by weight, based on the total amount of the free-radical initiator required in the aqueous polymerization medium and then, under polymerization conditions, during the free-radical emulsion polymerization of the monomers M to add the entire amount or any remaining residual amount, according to the consumption, batchwise in one or more portions or continuously with constant or varying flow rates.

In another preferred embodiment, the free-radical aqueous emulsion polymerization of the invention is conducted at temperatures in the range from 0 to 170° C.; more preferably in the range from 50 to 120° C., most preferably in the range from 60 to 120° C. and in particularly the free-radical aqueous emulsion polymerization of the invention is conducted at temperatures in the range from 70 to 110° C. The free-radical aqueous emulsion polymerization can be conducted at a pressure of less than, equal to or greater than 1 atm.

In certain embodiments, the polymerization is conducted in the presence of a chain transfer agent. The chain transfer agents are selected from the group consisting of aliphatic and/or araliphatic halogen compounds, for example n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide; organic thio compounds such as primary, secondary or tertiary aliphatic thiols, for example ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and the isomeric compounds thereof, n-octanethiol and the isomeric compounds thereof, n-nonanethiol and the isomeric compounds thereof, n-decanethiol and the isomeric compounds thereof, n-undecanethiol and the isomeric compounds thereof, n-dodecanethiol and the isomeric compounds thereof, n-tridecanethiol and isomeric compounds thereof, substituted thiols, for example 2-hydroxyethanethiol, aromatic thiols such as benzenethiol, ortho-, meta- or para-methylbenzenethiol, alkylesters of mercaptoacetic acid (thioglycolic acid) such as 2-ethylhexyl thioglycolate, alkylesters of mercaptopropionic acid such as octyl mercapto propionate, and also further sulfur compounds described in Polymer Handbook, 3rd edition, 1989, J. Brandrup and E. H. Immergut, John Wiley & Sons, section II, pages 133 to 141, and aliphatic and/or aromatic aldehydes such as acetaldehyde, propionaldehyde and/or benzaldehyde, unsaturated fatty acids such as oleic acid, dienes having nonconjugated double bonds, such as divinylmethane or vinylcyclohexane, or hydrocarbons having readily abstractable hydrogen atoms, for example toluene.

In general, the total amount of chain transfer agents, if present, does not exceed 1% by weight, based on the total amount of monomers M.

In general, the polymerization is conducted in presence of a surfactant. The surfactant can be selected from emulsifiers and protective colloids. The protective colloids, as opposed to emulsifiers, are understood to mean polymeric compounds having molecular weights above 2000 Daltons, whereas emulsifiers typically have lower molecular weights. The surfactants may be anionic or nonionic or mixtures of non-ionic and anionic surfactants.

The anionic surfactants usually bear at least one anionic group, which is selected from phosphate, phosphonate, sulfate and sulfonate groups. The anionic surfactants, which bear at least one anionic group, are typically used in the form of their alkali metal salts, especially of their sodium salts or in the form of their ammonium salts.

In preferred embodiments, the anionic surfactants are anionic emulsifiers which bear in particular at least one sulfate or sulfonate group. Likewise, anionic emulsifiers, which bear at least one phosphate or phosphonate group may be used, either as sole anionic emulsifiers or in combination with one or more anionic emulsifiers, which bear at least one sulfate or sulfonate group.

Examples of anionic emulsifiers, which bear at least one sulfate or sulfonate group, are, for example, the salts, especially the alkali metal and ammonium salts, of alkyl sulfates, especially of C₈-C₂₂-alkyl sulfates, the salts, especially the alkali metal and ammonium salts, of sulfuric monoesters of ethoxylated alkanols, especially of sulfuric monoesters of ethoxylated C₈-C₂₂-alkanols, preferably having an ethoxylation level (EO level) in the range from 2 to 40, the salts, especially the alkali metal and ammonium salts, of sulfuric monoesters of ethoxylated alkylphenols, especially of sulfuric monoesters of ethoxylated C₄-C₁₈-alkylphenols (EO level preferably 3 to 40), the salts, especially the alkali metal and ammonium salts, of alkylsulfonic acids, especially of C₈-C₂₂-alkylsulfonic acids, the salts, especially the alkali metal and ammonium salts, of dialkyl esters, especially di-C₁-C₁₈-alkyl esters of sulfosuccinic acid, the salts, especially the alkali metal and ammonium salts, of alkylbenzenesulfonic acids, especially of C₄-C₂₂-alkylbenzenesulfonic acids, and—the salts, especially the alkali metal and ammonium salts, of mono- or disulfonated, alkyl-substituted diphenyl ethers, for example of bis(phenylsulfonic acid) ethers bearing a C₄-C₂₄-alkyl group on one or both aromatic rings. The examples are U.S. Pat. No. 4,269,749, and Dowfax® 2A1 (Dow Chemical Company).

In particularly preferred embodiments, the anionic surfactants are anionic emulsifiers, which are selected from the following groups:
the salts, especially the alkali metal and ammonium salts, of alkyl sulfates, especially of C₈-C₂₂-alkyl sulfates,
the salts, especially the alkali metal salts, of sulfuric monoesters of ethoxylated alkanols, especially of sulfuric monoesters of ethoxylated C₈-C₂₂-alkanols, preferably having an ethoxylation level (EO level) in the range from 2 to 40,
sulfuric monoesters of ethoxylated alkylphenols, especially of sulfuric monoesters of ethoxylated C₄-C₁₈-alkylphenols (EO level preferably 3 to 40), of alkylbenzenesulfonic acids, especially of C₄-C₂₂-alkylbenzenesulfonic acids, and
mono- or disulfonated, alkyl-substituted diphenyl ethers, for example of bis(phenylsulfonic acid) ethers bearing a C₄-C₂₄-alkyl group on one or both aromatic rings.

Examples of anionic emulsifiers, which bear a phosphate or phosphonate group, include, but are not limited to the following salts are selected from the following groups:
the salts, especially the alkali metal and ammonium salts, of mono- and dialkyl phosphates, especially C₈-C₂₂-alkyl phosphates,
the salts, especially the alkali metal and ammonium salts, of phosphoric monoesters of C₂-C₃-alkoxylated alkanols, preferably having an alkoxylation level in the range from 2 to 40, especially in the range from 3 to 30, for example phosphoric monoesters of ethoxylated C₈-C₂₂-alkanols, preferably having an ethoxylation level (EO level) in the range from 2 to 40, phosphoric monoesters of propoxylated C₈-C₂₂-alkanols, preferably having a propoxylation level (PO level) in the range from 2 to 40, and phosphoric monoesters of ethoxylated-co-propoxylated C₈-C₂₂-alkanols, preferably having an ethoxylation level (EO level) in the range from 1 to 20 and a propoxylation level of 1 to 20,
the salts, especially the alkali metal and ammonium salts, of phosphoric monoesters of ethoxylated alkylphenols, especially phosphoric monoesters of ethoxylated C₄-C₁₈-alkylphenols (EO level preferably 3 to 40),
the salts, especially the alkali metal and ammonium salts, of alkylphosphonic acids, especially C₈-C₂₂-alkylphosphonic acids, and
the salts, especially the alkali metal and ammonium salts, of alkylbenzenephosphonic acids, especially C₄-C₂₂-alkylbenzenephosphonic acids.

Further suitable anionic surfactants can be found in Houben-Weyl, Methoden der organischen Chemie [Methods of Organic Chemistry], volume XIV/1, Makromolekulare Stoffe [Macromolecular Substances], Georg-Thieme-Verlag, Stuttgart, 1961, p. 192-208.

In other preferred embodiments, the surfactant comprises at least one anionic emulsifier, which bears at least one sulfate or sulfonate group. The at least one anionic emulsifier, which bears at least one sulfate or sulfonate group, may be the sole type of anionic emulsifiers. However, mixtures of at least one anionic emulsifier, which bears at least one sulfate or sulfonate group, and at least one anionic emulsifier, which bears at least one phosphate or phosphonate group, may also be used. In such mixtures, the amount of the at least one anionic emulsifier, which bears at least one sulfate or sulfonate group, is preferably at least 50% by weight, based on the total weight of anionic surfactants used in the process of the present invention. In particular, the amounts of anionic emulsifiers, which bear at least one phosphate or phosphonate group do not exceed 20% by weight, based on the total weight of anionic surfactants used in the process of the present invention.

In other preferred embodiments, the surfactant may also comprise one or more nonionic surface-active substances, which are especially selected from nonionic emulsifiers. Suitable nonionic emulsifiers are e.g. araliphatic or aliphatic nonionic emulsifiers, for example ethoxylated mono-, di- and trialkylphenols (EO level 3 to 50, alkylchain: C₄-C₁₀), ethoxylates of long-chain alcohols (EO level: 3 to 100, alkyl chain: C₈-C₃₆), and polyethylene oxide/polypropylene oxide homo- and copolymers. These may comprise the alkylene oxide units copolymerized in random distribution or in the form of blocks. Very suitable examples are the EO/PO block copolymers. Preference is given to ethoxylates of long-chain alkanols (alkyl chain C₁-C₃₀, mean ethoxylation level 5 to 100) and, among these, particular preference is given to those having a C₁₂-C₂₀ alkyl chain and a mean ethoxylation level of 5 to 20, and also to ethoxylated monoalkylphenols. Preferably, the surfactants used in the process of the present invention comprise less than 60% by weight, especially not more than 50% by weight, of nonionic surfactants, based on the total amount of surfactants used in the process of the present invention.

In other embodiments, the surfactants used in the process of the present invention comprise at least one anionic surfactant and at least one nonionic surfactant, the ratio of anionic surfactants to non-ionic surfactants being usually in the range from 0.5:1 to 10:1, in particular from 1:1 to 5:1.

In other preferred embodiments, the surfactant/surfactants will be used in such an amount that the amounts of surfactant/surfactants are in the range from 0.2% to 5% by weight, especially in the range from 0.5% to 3% by weight, based on the monomers M to be polymerized.

The aqueous reaction medium in polymerization may in principle also comprise minor amounts (≤5% by weight) of water-soluble organic solvents, for example methanol, ethanol, isopropanol, butanols, pentanols, but also acetone, etc. Preferably, however, the process of the invention is conducted in the absence of such solvents.

In general, the aqueous polymer dispersions obtained have polymer solid contents in the range from 10% to 70% by weight, preferably 20% to 65% by weight, more preferably 30% to 60% by weight, and most preferably 40% to 60% by weight, based in each case on the total weight of the aqueous polymer dispersion.

It has been found advantageous to perform the free-radical emulsion polymerization in the presence of a seed latex. A seed latex is a polymer latex which is present in the aqueous polymerization medium before the metering of the monomers M is started. The seed latex may help to better adjust the particle size of the final polymer latex obtained in the free-radical emulsion polymerization of the invention.

Principally every polymer latex may serve as a seed latex. For the purpose of the invention, preference is given to seed latices, where the particle size of the polymer particles is comparatively small. The Z average particle diameter of the polymer particles of the seed latex, as determined by dynamic light scattering at 20° C. is preferably in the range from 10 to 80 nm, in particular from 10 to 50 nm. Preferably, the polymer particles of the seed latex are made of ethylenically unsaturated monomers, which comprise at least 95% by weight, based on the total weight of the monomers forming the seed latex, of one or more monomers selected from C₂-C₁₀-alkyl esters of acrylic acid, in particular ethyl acrylate, n-butyl acrylate, n-hexyl acrylate, n-octyl acrylate, 2-ethyl-hexylacrylate, C₁-C₄-alkyl esters of methacrylic acid, in particular methyl methacrylate, and vinylaromatic monomers, in particular styrene.

For this, the seed latex is usually charged into the polymerisation vessel before the metering of the monomers M is started. In particular, the seed latex is charged into the polymerisation vessel followed by establishing the polymerization conditions and charging at least a portion of the free-radical initiator into the polymerisation vessel before the metering of the monomers M is started.

The amount of seed latex, calculated as solids, may frequently be in the range from 0.1 to 10% by weight, in particular from 0.5 to 5% by weight, based on the total weight of the monomers M a), b), c) and d) to be polymerized.

The present invention also relates to an aqueous coating composition comprising:
i) at least one aqueous polymer latex as defined above; and
ii) a titanium dioxide pigment.

The present invention also relates to the use of the aqueous polymer latex as a binder in an aqueous coating composition containing a titanium dioxide pigment.

The TiO₂ concentration of an aqueous TiO₂ pigment slurry or paste used for preparing the aqueous dispersion of the polymer composite will generally be in the range from 30% to 85% by weight, frequently 40% to 80% by weight and, based in each case on the total weight of the aqueous TiO₂ pigment slurry or paste. The titanium dioxide pigment used for preparing the aqueous dispersion of the polymer composite may be any TiO₂ pigment conventionally used in coating compositions, in particular in aqueous coating compositions. Frequently, a TiO₂ pigment is used wherein the TiO₂ particles are preferably in the rutile form. In another preferred embodiment the TiO₂ particles can also be coated e.g. with aluminum, silicon and zirconium compounds.

In general, the weight ratio of the polymer to the titanium dioxide pigment is in the range of ≥0.1:5.0 to ≤5.0:0.1; preferably the weight ratio of the polymer to the titanium dioxide pigment is in the range of ≥0.5:5.0 to ≤5.0:0.5; in particular more preferably the weight ratio of the polymer to the titanium dioxide pigment is in the range of ≥0.5:3.0 to ≤3.0:0.5 and in particular in the range of ≥0.5:1.5 to ≤1.5:0.5.

Preferably, the titanium dioxide pigment has an average primary particle size in the range of ≥0.1 μm to ≤0.5 μm, as determined by light scattering or by electron microscopy.

In general, the aqueous coating composition further comprises at least one additive selected from the group consisting of thickeners, defoamers, levelling agents, filming auxiliaries, biocides, wetting agents or dispersants, fillers and coalescing agents.

The aqueous coating composition can be simply prepared by mixing TiO₂ pigment powder or an aqueous slurry or paste of TiO₂ pigment with the aqueous polymer latex of the invention, preferably by applying shear to the mixture, e.g. by using a dissolver conventionally used for preparing water-borne paints. It will also be possible to prepare an aqueous slurry or paste of TiO₂ pigment and the aqueous polymer latex of the invention, which is then incorporated into or mixed with further polymer latex of the invention or with any other polymer latex binder.

The aqueous dispersion of the polymer composite may also be prepared by incorporating the aqueous polymer latex of the invention as a binder or co-binder in an aqueous base formulation of a paint, which already contains a TiO₂ pigment, e.g. by mixing the aqueous polymer latex of the invention with a pigment formulation that already contains further additives conventionally used in the paint formulation.

In order to stabilize the TiO₂ pigment particles in the aqueous pigment slurry or paste, the mixing may optionally be performed in the presence of additives conventionally used in aqueous pigment slurries or pigment pastes, such as dispersants. Suitable dispersants include but are not limited to, for example, polyphosphates such as sodium polyphosphates, potassium polyphosphates or ammonium polyphosphates, alkali metal salts and ammonium salts of acrylic acid homo- or copolymers or maleic anhydride polymers, polyphosphonates, such as sodium 1-hydroxyethane-1,1-diphosphonate, and naphthalenesulfonic salts, especially the sodium salts thereof.

The polymer concentration in the aqueous polymer latex used for preparing the aqueous dispersion of the polymer composite is generally in the range from 10% to 70% by weight, preferably 20% to 65% by weight and most preferably 30% to 60% by weight, based in each case on the total weight of the aqueous polymer latex.

In addition to the polymer latex of the present invention and a titanium dioxide pigment and an optional conventional binder, the aqueous coating compositions may contain one or more pigments different from the TiO₂ pigment and/or fillers.

Suitable pigments different from the TiO₂ pigment are, for example, inorganic white pigments such as barium sulfate, zinc oxide, zinc sulfide, basic lead carbonate, antimony trioxide, lithopone (zinc sulfide+barium sulfate), or colored pigments, for example iron oxides, carbon black, graphite, zinc yellow, zinc green, ultramarine, manganese black, antimony black, manganese violet, Prussian blue or Paris green. In addition to the inorganic pigments, the emulsion paints of the invention may also comprise organic color pigments, for example sepia, gamboge, Cassel brown, toluidine red, para red, Hansa yellow, indigo, azo dyes, anthraquinonoid and indigoid dyes, and also dioxazine, quinacridone pigments, phthalocyanine pigments, isoindolinone pigments and metal complex pigments. Also suitable are synthetic white pigments with air inclusions to enhance light scattering, such as the Ropaque® and AQACell® dispersions. Additionally suitable are the Luconyl® brands from BASF SE, for example Luconyl® yellow, Luconyl® brown and Luconyl® red, particularly the transparent versions.

Preferred fillers are selected from the group consisting of aluminosilicates such as feldspars, silicates such as kaolin, talc, mica and magnesite; alkaline earth metal carbonates such as calcium carbonate in the form of calcite or chalk, magnesium carbonate and dolomite; alkaline earth metal sulfates such as calcium sulfate, silicon dioxide, etc. In the coating compositions of the invention, finely divided fillers are naturally preferred. The fillers may be used in the form of individual components. In practice, however, filler mixtures have been found to be particularly useful, for example calcium carbonate/kaolin, calcium carbonate/talc. Gloss paints generally comprise only small amounts of very finely divided fillers, or do not comprise any fillers. Fillers also include flatting agents which significantly impair the gloss as desired. Flatting agents are generally transparent and may be either organic or inorganic. Examples of flatting agents are inorganic silicates, for example the Syloid® brands from W. R. Grace & Company and the Ace-matt® brands from Evonik GmbH. Organic flatting agents are obtainable, for example, from BYK-Chemie GmbH under the Ceraflour® brands and the Ceramat® brands, and from Deuteron GmbH under the Deuteron MK® brand.

The proportion of the pigments and fillers in the coating compositions can be described in a manner known per se via the pigment volume concentration (PVC). The PVC describes the ratio of the volume of pigments (VP) and fillers (VF) relative to the total volume, consisting of the volumes of binder (VB), pigments (VP) and fillers (VF) in a dried coating film in percent:

$$PVC = ( VP + VF ) \times 100 / ( VP + VF + VB ) .$$

Preferably, the pigment volume concentration PVC of the coating compositions of the invention is ≤35%.

In further preferred embodiments, wetting agents are selected from the group consisting of sodium polyphosphates, potassium polyphosphates or ammonium polyphosphates, alkali metal salts and ammonium salts of acrylic acid copolymers or maleic anhydride copolymers, polyphosphonates, such as sodium 1-hydroxyethane-1,1-diphosphonate, and naphthalenesulfonic salts, especially the sodium salts thereof.

Suitable filming auxiliaries are, for example, Texanol or Optifilm from Eastman Chemicals and the glycol ethers and esters, commercially available, for example, from BASF SE under the Solvenon and Lusolvan names, and from Dow under the Dowanol trade name. The amount of filming auxiliaries is preferably less than 10% by weight and more preferably less than 5% by weight, based on the overall formulation.

Suitable thickeners are, for example, associative thickeners, such as polyurethane thickeners. The amount of thickeners is generally less than 5% by weight and more preferably less than 3% by weight of thickener based on the overall formulation.

Further formulation ingredients for water-borne paints are described in detail in M. Schwartz and R. Baumstark “Water-based Acrylates for Decorative Coatings”, Curt R. Vincentz Verlag, Hanover, 2001, p. 191-212 (ISBN 3-87870-726-6).

The coating compositions may be applied to substrates in a customary manner, for example by painting, spraying, dipping, rolling, bar coating.

In this case, the coating of substrates is effected in such a way that the substrate is first coated with an aqueous coating formulation of the invention and then the aqueous coating is subjected to a drying step, especially within the temperature range of from −10 to 50° C. advantageously from 5 to 40° C. and especially advantageously from 10 to 35° C.

The invention is further illustrated by the following examples.

### EXAMPLES

The following components are used in the present examples:

| Common name/IUPAC Name | Commercial name | Available from |
|---|---|---|
| Methyl methacrylate | Methyl methacrylate | BASF SE |
| 2-Octyl acrylate | 2-Octyl acrylate | BASF SE |
| n-Butyl acrylate | n-Butyl acrylate | BASF SE |
| Acrylic acid | Acrylic acid | BASE SE |
| Acrylamide | Acrylamide | BASF SE |
| Polystyrene seed dispersion | Polystyrene seed dispersion | BASF SE |
| Alkyldiphenyloxide Disulfonate | Dowfax ® 2A1 | Dow Chemicals |
| C₁₃H₂₇O(CH₂CH₂O)xH | Lutensol ® TO 82 | BASF SE |
| Sodium persulfate | Sodium persulfate | Sigma Aldrich |
| t-Butylhydroperoxide | t-Butylhydroperoxide | BASF SE |
| Sodium hydroxymethanesulfinate | Rongalit ® C | Brueggemann |
| Titanium Dioxide | Kronos 4311 | Kronos Worldwide, Inc |
| Neutralizer containing 2-amino-2- | AMP-95 | Angus Chemical |
| methyl-1-propanol | | Company |
| Ammonium salt of a hydrophobic | Tamol 165 A | Dow |
| copolymer as dispersant | | |
| Hyperbranched polymer | Foamstar 2420 | BASF SE |
| defoamer | | |
| Nonvolatile, non-ionic surfactant | Hydropalat WE 3320 | BASF SE |
| as surface levelling and wetting | | |
| agent | | |
| Non-ionic associative thickener | Aquaflow ® NHS-310 | Ashland |
| Polymeric pigment | Ropaque Ultra E | Dow |
| Filler produced from nepheline | Minex 10 | Sibelco |
| syenite | | |
| Coalescing agent 2,2,4-Trimethyl- | Texanol | Eastman |
| 1,3-pentandiol monoisobutyrate | | |
| Low odor coalescing agent | Optifilm 400 | Eastman |
| Biocide | Proxel AQ | Lonza |
| Fungicide | Polyphase 663 | Troy Corporation |
| Non-ionic associative thickener | Rheolate CVS 10 | Elementis |
| Non-ionic associative thickener | Acrysol RM 895 | Dow |
| Attapulgite clay | Attagel 50 | BASF SE |

### Example E1

Binder Based on a Polymer with 2-Octyl Acrylate, n-Butyl Acrylate and Methyl Methacrylate

A reactor equipped with stirrer, temperature control, nitrogen inlet and several injection possibilities is charged with 244.3 g deionized water, 27.3 g polystyrene seed dispersion (33 wt %, particle diameter: 30 nm). The reaction mixture is purged with nitrogen and heated to 85° C. At 85° C. 5.0 g of feed 2 are added. After 5 min, feed 1 and feed 2 are added in 180 min. Feed 1:400.5 g deionized water, 18.5 g Dowfax 2A1, 20.8 g Lutensol TO 82, 6.9 g acrylic acid, 13.9 g acrylamide (50 wt % aqueous solution), 34.8 g 2-octyl acrylate, 349.0 g methyl methacrylate, 300.0 g n-butyl acrylate. Feed 2:19.8 g aqueous sodium persulfate solution (7 wt %). The reaction mixture is post-polymerized at 85° C. for 30 min. Then feed 3 and feed 4 are added in 60 min. Feed 3:6.9 g aqueous t-butylhydroperoxide solution (10 wt %). Feed 4:6.2 g aqueous Rongalit C solution (10 wt %). Then the reaction mixture is cooled down to ambient temperature and neutralized with sodium hydroxide to pH 8-9.
Tg (dried dispersion): 21° C.
Average particle diameter: 133 nm
Solid contents: 48.7 wt %

### Example E2

Binder Based on a Polymer with 2-Octyl Acrylate, n-Butyl Acrylate and Methyl Methacrylate

A reactor equipped with stirrer, temperature control, nitrogen inlet and several injection possibilities is charged with 244.3 g deionized water, 27.3 g polystyrene seed dispersion (33 wt %, particle diameter: 30 nm). The reaction mixture is purged with nitrogen and heated to 85° C. At 85° C. 5.0 g of feed 2 are added. After 5 min, feed 1 and feed 2 are added in 180 min. Feed 1:400.5 g deionized water, 18.5 g Dowfax 2A1, 20.8 g Lutensol TO 82, 6.9 g acrylic acid, 13.9 g acrylamide (50 wt % aqueous solution), 69.5 g 2-octyl acrylate, 349.0 g methyl methacrylate, 265.0 g n-butyl acrylate. Feed 2:19.8 g aqueous sodium persulfate solution (7 wt %). The reaction mixture is post-polymerized at 85° C. for 30 min. Then feed 3 and feed 4 are added in 60 min. Feed 3:6.9 g aqueous t-butylhydroperoxide solution (10 wt %). Feed 4:6.2 g aqueous Rongalit C solution (10 wt %). Then the reaction mixture is cooled down to ambient temperature and neutralized with sodium hydroxide to pH 8-9.
Tg (dried dispersion): 17° C.
Average particle diameter: 132 nm
Solid contents: 48.0 wt %

### Comparative Example C1

Binder Based on a Polymer with n-Butyl Acrylate and Methyl Methacrylate

A reactor equipped with stirrer, temperature control, nitrogen inlet and several injection possibilities is charged with 244.3 g deionized water, 27.3 g polystyrene seed dispersion (33 wt %, particle diameter: 30 nm). The reaction mixture is purged with nitrogen and heated to 85° C. At 85° C. 5.0 g of feed 2 are added. After 5 min, feed 1 and feed 2 are added in 180 min. Feed 1:400.5 g deionized water, 18.5 g Dowfax 2A1, 20.8 g Lutensol TO 82, 6.9 g acrylic acid, 13.9 g acrylamide (50 wt % aqueous solution), 349.0 g methyl methacrylate, 335.0 g n-butyl acrylate. Feed 2:19.8 g aqueous sodium persulfate solution (7 wt %). The reaction mixture is post-polymerized at 85° C. for 30 min. Then feed 3 and feed 4 are added in 60 min. Feed 3:6.9 g aqueous t-butylhydroperoxide solution (10 wt %). Feed 4:6.2 g aqueous Rongalit C solution (10 wt %). Then the reaction mixture is cooled down to ambient temperature and neutralized with sodium hydroxide to pH 8-9.
Tg (dried dispersion): 19° C.
Average particle diameter: 132 nm
Solid contents: 48.1 wt %

### Example E3

Formulation of Semi-Gloss Paint with Binder from Example E1

315.0 g Kronos 4311 pigment is mixed with 15.0 g water. At low stirring speed 1.75 g AMP-95 neutralizer (Angus Chemical Company), 5.0 g propylene glycol (Univar), 2.0 g Foamstar 2420 defoamer (BASF), 10.0 g Tamol 165 A dispersant (Dow) and 3.0 g Hydropalat WE 3320 wetting agent (BASF) are added. At high stirring speed 1.5 g Attagel 50 (BASF), 25.0 g Minex 10 (Sibelco) filler and 20.0 g Aquaflow NHS-310 (Ashland) non-ionic associative thickener are added and mixed for 30 min. Subsequently, 105.8 g deionized water are added and the mixture is filtered through a 400 μm filter. Then 496.8 g binder from Example E1, 25.0 g Ropaque Ultra E polymeric pigment (Dow), 2.0 g Foamstar 2420 defoamer (BASF), 9.0 g Texanol coalescing agent (Eastman) and 7.5 g Optifilm 400 coalescing agent (Eastman) are added and mixed for 5 min. Then 2.0 g Proxel AQ biocide (Lonza), 3.0 g Polyphase 663 fungicide (Troy Corporation) and 2.0 g Rheolate CVS 10 non-ionic associative thickener (Elementis) are added and mixed for 5 min. Finally, 2.0 g Acrysol RM 895 non-ionic associative thickener (Dow) and 3.5 g water are added and the mixture is stirred for 30 min at medium speed.

### Example E4

Formulation of Semi-Gloss Paint with Binder from Example E2

315.0 g Kronos 4311 pigment is mixed with 15.0 g water. At low stirring speed 1.75 g AMP-95 neutralizer (Angus Chemical Company), 5.0 g propylene glycol (Univar), 2.0 g Foamstar 2420 defoamer (BASF), 10.0 g Tamol 165 A dispersant (Dow) and 3.0 g Hydropalat WE 3320 wetting agent (BASF) are added. At high stirring speed 1.5 g Attagel 50 (BASF), 25.0 g Minex 10 (Sibelco) filler and 20.0 g Aquaflow NHS-310 (Ashland) non-ionic associative thickener are added and mixed for 30 min. Subsequently, 96.3 g deionized water are added and the mixture is filtered through a 400 μm filter. Then 504.0 g binder from Example E2, 25.0 g Ropaque Ultra E polymeric pigment (Dow), 2.0 g Foamstar 2420 defoamer (BASF), 9.0 g Texanol coalescing agent (Eastman) and 6.0 g Optifilm 400 coalescing agent (Eastman) are added and mixed for 5 min. Then 2.0 g Proxel AQ biocide (Lonza), 3.0 g Polyphase 663 fungicide (Troy Corporation) and 2.0 g Rheolate CVS 10 non-ionic associative thickener (Elementis) are added and mixed for 5 min. Finally, 2.0 g Acrysol RM 895 non-ionic associative thickener (Dow) and 5.1 g water are added and the mixture is stirred for 30 min at medium speed.

### Comparative Example C2

Formulation of Semi-Gloss Paint with Binder from Example C1

315.0 g Kronos 4311 pigment is mixed with 15.0 g water. At low stirring speed 1.75 g AMP-95 neutralizer (Angus Chemical Company), 5.0 g propylene glycol (Univar), 2.0 g Foamstar 2420 defoamer (BASF), 10.0 g Tamol 165 A dispersant (Dow) and 3.0 g Hydropalat WE 3320 wetting agent (BASF) are added. At high stirring speed 1.5 g Attagel 50 (BASF), 25.0 g Minex 10 (Sibelco) filler and 20.0 g Aquaflow NHS-310 (Ashland) non-ionic associative thickener are added and mixed for 30 min. Subsequently, 100.0 g deionized water are added and the mixture is filtered through a 400 μm filter. Then 503.0 g binder from Example C1, 25.0 g Ropaque Ultra E polymeric pigment (Dow), 2.0 g Foamstar 2420 defoamer (BASF), 9.0 g Texanol coalescing agent (Eastman) and 5.0 g Optifilm 400 coalescing agent (Eastman) are added and mixed for 5 min. Then 2.0 g Proxel AQ biocide (Lonza), 3.0 g Polyphase 663 fungicide (Troy Corporation) and 3.2 g Rheolate CVS 10 non-ionic associative thickener (Elementis) are added and mixed for 5 min. Finally, 1.5 g Acrysol RM 895 non-ionic associative thickener (Dow) and 5.4 g water are added and the mixture is stirred for 30 min at medium speed.

### Scrub Resistance Measured According to ASTM D2486:

Number of scrub cycles on a coating from E3 before a failure occurs: 1411
Number of scrub cycles on a coating from E4 before a failure occurs: 1247
Number of scrub cycles on a coating from C₂ before a failure occurs: 1158

Scrub resistance is significantly improved for Examples E3 and E4 as compared to Example C₂.

### Determination of Gloss:

A coating film was prepared with a 3 mils drawdown bar on a Leneta 3B black and white sealed drawdown card. The film is dried at room temperature for 24 hours. Gloss was measured with a gloss meter. The results were as follows:
Gloss (20°) of a coating from Example E3:8.4
Gloss (20°) of a coating from Example E4:8.4
Gloss (20°) of a coating from Example C2:7.7
Gloss (60°) of a coating from Example E3:42.2
Gloss (60°) of a coating from Example E4:42.3
Gloss (60°) of a coating from Example E4:40.8
Gloss (85°) of a coating from Example E3:81.8
Gloss (85°) of a coating from Example E4:81.7
Gloss (85°) of a coating from Example C2:80.9

Gloss is improved for Examples E3 and E4 as compared to Example C2.

### Low Shear Viscosity Measured According to ASTM D562:

Low shear viscosity of a coating from Example of E3 (7 days after preparation): 96.2 KU
Low shear viscosity of a coating from Example of E4 (7 days after preparation): 95.6 KU
Low shear viscosity of a coating from Example of C2 (7 days after preparation): 94.8 KU

### Determination of Opacity:

A coating film was prepared with a 3 mils drawdown bar on a Leneta 3B black and white sealed drawdown card. The film is dried at room temperature for 24 hours. The opacity was determined spectrophotometrically as the ratio of reflected light from the dried coating over the black portions and the white portions of the Laneta card. The opacity indicates the capability of the coating to hide the black surface. The results were as follows:
Opacity of coating from Example E3:97.52%
Opacity of coating from Example E4:97.53%
Opacity of coating from Example C2:97.51%

Intercoat, aluminium and alkyd adhesion measured according to ASTM D3359: comparable for coatings from E3, E4 and C2.

Stain removal according to ASTM D4828: comparable for coatings from E3, E4 and C2 for pencil, lipstick, crayon, ballpen, red wine, ketchup, coffee, mustard (assessment by visual inspection).

### Determination of Dirt Pick-Up:

The mill glaze on yellow pine wood surface is scrubbed with water and dried overnight.

The substrate is divided into sections depending on the number of samples to be tested. Using the appropriate brush, the test paint samples are applied at natural spread rate. The coatings are cured at room temperature for the period of 4 hours and 24 hours, respectively. Then, half of the coated area is covered with 2 inches of dry dirt (Arizona or Carpet soil). The panel is allowed to sit for 15 minutes, then tilted vertically and tapped to release dirt. The dirty area of each sample is lightly brushed (15 strokes).

Dirt pick-up is comparable for coatings from Examples E3, E4 and Example C2 (assessment by visual evaluation).

1.-15. (canceled)

16. An aqueous polymer latex obtainable by polymerizing, optionally in the presence of a seed latex, a monomer composition M by radical emulsion polymerization, wherein the monomer composition M comprises, based on the total weight of the monomer composition M:
a) 0.5 to 30% by weight of 2-octyl acrylate,
b) 25 to 55% by weight of n-butyl acrylate,
c) 35 to 65% by weight of methyl methacrylate,
d) 0 to 5% by weight of one or more monoethylenically unsaturated carboxylic acids,
e) 0 to 5% by weight of one or more monoethylenically unsaturated carboxylic acid amides,
f) 0 to 10% by weight of one or more further ethylenically unsaturated non-ionic monomers different from monomers a), b), c), d) and e).

17. The aqueous polymer latex of claim 16, wherein monomer d) is selected from the group consisting of acrylic acid, methacrylic acid and itaconic acid.

18. The aqueous polymer latex of claim 16, wherein monomer e) is selected from the group consisting of acrylamide and methacrylamide.

19. The aqueous polymer latex of claim 16, wherein monomer d) is present in an amount of 0.1 to 4% by weight.

20. The aqueous polymer latex of claim 16, wherein monomer e) is present in an amount of 0.1 to 4% by weight.

21. The aqueous polymer latex of claim 16, wherein the monomer composition M comprises:
a) 1 to 15% by weight by weight of 2-octyl acrylate,
b) 25 to 55% by weight by weight of n-butyl acrylate,
c) 40 to 65% by weight by weight of methyl methacrylate,
d) 0 to 5% by weight of one or more monoethylenically unsaturated carboxylic acids,
e) 0 to 5% by weight of one or more monoethylenically unsaturated carboxylic acid amides.

22. The aqueous polymer latex of claim 16, wherein the monomer composition M consists of:
a) 3 to 12% by weight of 2-octyl acrylate,
b) 30 to 50% by weight of n-butyl acrylate,
c) 40 to 60% by weight of methyl methacrylate,
d) 0.1 to 4% by weight of a monoethylenically unsaturated carboxylic acid, selected from acrylic acid, methacrylic acid and itaconic acid,
e) 0.1 to 4% by weight of a monoethylenically unsaturated carboxylic acid amide, selected from acrylamide and methacrylamide.

23. The aqueous polymer latex of claim 16, wherein the monomer composition M consists of:
a) 3 to 12% by weight of 2-octyl acrylate,
b) 30 to 50% by weight of n-butyl acrylate,
c) 40 to 60% by weight of methyl methacrylate,
d) 0.5 to 3% by weight by weight of acrylic acid,
e) 0.5 to 3% by weight by weight of acrylamide.

24. The aqueous polymer latex of claim 16, wherein the monomer composition M is polymerized in the presence of from 0.1 to 10% by weight, based on the total weight of the monomer composition M, of a seed latex made of one or more ethylenically unsaturated monomers.

25. The aqueous polymer latex of claim 24, wherein the seed latex is made of one or more ethylenically unsaturated monomers selected from the group consisting of C₂-C₁₀-alkyl esters of acrylic acid, C₁-C₄-alkyl esters of methacrylic acid and vinylaromatic monomers.

26. The aqueous polymer latex of claim 16, wherein at least part of the 2-octyl acrylate has been obtained from renewable raw materials.

27. The copolymer contained in the aqueous polymer latex of claim 16.

28. An aqueous coating composition comprising:
i) an aqueous polymer latex of claim 16,
ii) a titanium dioxide pigment.

29. The aqueous coating composition of claim 28, wherein the weight ratio of the copolymer to the titanium dioxide pigment is in the range of from 0.1:5.0 to 5.0:0.1.

30. The use of an aqueous polymer latex of claim 16 as a binder in an aqueous coating composition containing a titanium dioxide pigment.
